(19) United States
(12) Patent Application Publication
(10) Pub. No.: US 2025/0383302 A1
(43) Pub. Date: Dec. 18, 2025

(54) RADIOGRAPHIC IMAGING APPARATUS, RADIOGRAPHIC IMAGING METHOD, AND NON-TRANSITORY COMPUTER-READABLE RECORDING MEDIUM STORING RADIOGRAPHIC IMAGING PROGRAM

(71) Applicant: Konica Minolta, Inc., Tokyo (JP)

(72) Inventors: Atsushi TANEDA, Tokyo (JP); Keisuke KOEDA, Saitama (JP); Nobuyuki MIYAKE, Kanagawa (JP); Naoki HAYASHI, Tokyo (JP)

(21) Appl. No.: 19/232,981

(22) Filed: Jun. 10, 2025

(30) Foreign Application Priority Data
Jun. 14, 2024 (JP) 2024-096831

(51) Int. Cl. G01N 23/04

(52) U.S. Cl. CPC G01N 23/04; G01N 2223/306; G01N 2223/408

(57) ABSTRACT

Provided is a radiographic imaging apparatus that includes: at least one hardware processor that controls the imager such that the imager operates in a first imaging mode in which the imager performs one or both of the still image capturing and the dynamic image capturing a plurality of times between a start of an operation of the imager and an end of the operation of the imager according to one imaging instruction; and a storage that stores information, which is information on the one imaging instruction, in association with images for the plurality of times which have been captured in the first imaging mode.

### CROSS REFERENCE TO RELATED APPLICATIONS

The entire disclosure of Japanese Patent Application No. 2024-096831, filed on Jun. 14, 2024, is incorporated herein by reference in its entirety.

### BACKGROUND

### Technological Field

The present invention relates to a radiographic imaging apparatus, a radiographic imaging method, and a non-transitory computer-readable recording medium storing a radiographic imaging program.

### Description of Related Art

There is known a fluoroscopic imaging apparatus which, in order to observe the inside of the body of a patient (subject) in real time, irradiates the patient with radiation to perform imaging and displays a moving image of the inside of the body of the patient in real time (see, for example, Japanese Patent Application Laid-Open No. 2021-023748). For example, in a case where a treatment of inserting a catheter into the body of a patient is performed, such a fluoroscopic imaging apparatus is often used.

The fluoroscopic imaging apparatus requires a dedicated system, is installed in a dedicated imaging room, and cannot be used in situations different from that in the imaging room, such as doctor's hospital rounds and emergencies, due to a large amount of exposure. For this reason, for example, in the case of a follow-up observation during treatment, in a case where an in-vivo situation at the time of injection of a contrast agent is desired to be imaged and checked, or the like, it is necessary to move to a dedicated imaging room and perform imaging regardless of the physical condition or state of the patient, which imposes a heavy burden on the patient.

In contrast to such a fluoroscopic imaging apparatus, a radiographic imaging apparatus that displays the inside of a patient's body as a moving image or performs image analysis by continuous imaging by pulse irradiation of radiation, which is, however, an extension of an existing imaging technique using radiation, has started to spread. Such a radiographic imaging apparatus can be mounted on a medical cart or the like and makes it possible to capture, by performing radiation exposure management such as setting an upper limit of an amount of exposure, a moving image even at places where a doctor's hospital rounds take place, or the like, where a fluoroscopic imaging apparatus cannot be used.

The radiographic imaging apparatus cannot perform unlimited radiation irradiation unlike the fluoroscopic imaging apparatus due to the limitation of the amount of exposure at places where a doctor's hospital rounds take place, or the like, and needs to perform imaging in fixed periods of time into which a period of time is divided. On the other hand, the radiographic imaging apparatus may repeatedly perform imaging according to treatment for a patient or the like. Accordingly, the radiographic imaging apparatus is required to perform imaging in which a plurality of types and a plurality of times of imaging are repeatedly performed in fixed periods of time into which a period of time is divided. In addition, the number of times of imaging may dynamically change according to, for example, an imaging situation, a treatment situation, or the like.

However, the above-described radiographic imaging apparatus performs one imaging for one imaging order for instructing imaging, and cannot cope with a case in which imaging is performed in fixed periods of time into which a period of time is divided (a plurality of times of imaging is performed). For this reason, in a case where a plurality of times of imaging is performed, a new imaging order is required each time, and one imaging is performed in response to each of a plurality of imaging orders. As described above, in a case where a plurality of times of imaging is performed by the above-described radiographic imaging apparatus, it takes time and effort to perform an operation, and operability with respect to images for a plurality of times which are captured by the plurality of times of imaging is not good. Note that, in the above-described fluoroscopic imaging apparatus, a recording operation is required to be performed separately from an exposure operation in order to record an image by imaging for an imaging order, and operability is not good in a case where the recording operation is performed a plurality of times.

### SUMMARY

An object of the present invention is to provide a radiographic imaging apparatus, a radiographic imaging method, and a non-transitory computer-readable recording medium storing a radiographic imaging program, each of which is capable of improving operability for captured images for a plurality of times even when a plurality of times of imaging is performed during an operation according to one capturing instruction.

In order to realize at least one of the above-described objects, a radiographic imaging apparatus reflecting one aspect of the present invention includes: an imager that performs irradiation of radiation and performs still image capturing and dynamic image capturing; at least one hardware processor that controls the imager such that the imager operates in a first imaging mode in which the imager performs one or both of the still image capturing and the dynamic image capturing a plurality of times between a start of an operation of the imager and an end of the operation of the imager according to one imaging instruction; and a storage that stores information, which is information on the one imaging instruction, in association with images for the plurality of times, which have been captured in the first imaging mode.

In order to realize at least one of the above-described objects, a radiographic imaging method reflecting one aspect of the present invention includes: controlling, by a radiographic imaging apparatus including an imager that performs irradiation of radiation and performs still image capturing and dynamic image capturing, the imager such that the imager operates in a first imaging mode in which the imager performs one or both of the still image capturing and the dynamic image capturing a plurality of times between a start of an operation of the imager and an end of the operation of the imager according to one imaging instruction; and storing, by the radiographic imaging apparatus, information, which is information on the one imaging instruction, in association with images for the plurality of times which have been captured in the first imaging mode.

In order to achieve at least one of the abovementioned objects, a non-transitory computer-readable recording medium storing a radiographic imaging program reflecting one aspect of the present invention is a non-transitory computer-readable recording medium storing a radiographic imaging program that causes a computer of a radiographic imaging apparatus, which includes an imager that performs irradiation of radiation and performs still image capturing and dynamic image capturing, to execute:
controlling the imager such that the imager operates in a first imaging mode in which the imager performs one or both of the still image capturing and the dynamic image capturing a plurality of times between a start of an operation of the imager and an end of the operation of the imager according to one imaging instruction; and
storing information, which is information on the one imaging instruction, in association with images for the plurality of times which have been captured in the first imaging mode.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an exemplary overall configuration of a radiographic imaging system including a radiographic imaging apparatus;

FIG. 2 is a block diagram illustrating a functional configuration of an apparatus body which constitutes the radiographic imaging apparatus;

FIG. 3 is a diagram schematically illustrating pulse irradiation in a normal mode;

FIG. 4 is a diagram schematically illustrating pulse irradiation in an intermittent imaging mode;

FIG. 5 is a diagram describing a main imaging order and sub-imaging orders;

FIG. 6 is a flowchart describing a radiographic imaging method which is performed by the radiographic imaging apparatus;

FIG. 7 is a diagram which schematically describes the radiographic imaging method illustrated in FIG. 6, and which describes a case where there is no preset for sub-imaging orders;

FIG. 8 is a diagram which schematically describes the radiographic imaging method illustrated in FIG. 6, and which describes a case where there is a preset for sub-imaging orders;

FIG. 9 is a diagram illustrating an exemplary distinguished display of a main imaging order and sub-imaging orders;

FIG. 10 is a diagram describing an example in which captured images of a plurality of sub-imaging orders included in a main imaging order are combined into one and output to an external apparatus;

FIG. 11 is a diagram describing an example in which captured images of a plurality of sub-imaging orders included in a main imaging order are individually output to an external apparatus;

FIG. 12 is a flowchart describing a radiographic imaging method which is performed by the radiographic imaging apparatus, and which includes determination of allowing imaging to be added;

FIG. 13 is a diagram schematically describing an example in which imaging of a sub-imaging order is not allowed to be added;

FIG. 14 is a diagram schematically describing an example in which imaging is allowed to be added in a case where a captured image of a sub-imaging order is an image failure;

FIG. 15 is a diagram schematically describing an example in which imaging is allowed to be added in a case where a captured image of a main imaging order is an image failure; and

FIG. 16 is a diagram illustrating exemplary displaying in a case where imaging of a sub-imaging order is not allowed to be added.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

### [Radiographic Imaging Apparatus]

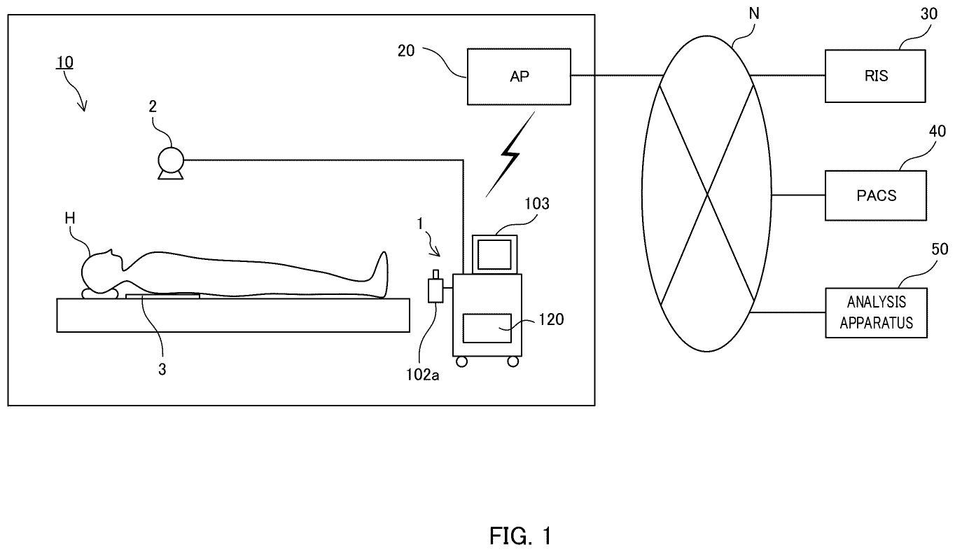

FIG. 1 is a diagram illustrating an exemplary overall configuration of a radiographic imaging system including a radiographic imaging apparatus 10 according to the present embodiment.

The radiographic imaging apparatus 10 is, for example, an apparatus for performing dynamic imaging of a patient with mobility difficulties during a doctor's hospital rounds. The radiographic imaging apparatus 10 includes an apparatus body 1, a radiation source 2, and a flat panel detector (FPD) 3. The apparatus body 1 includes wheels and is configured as a movable medical cart. Note that, the radiographic imaging apparatus 10 may be a portable apparatus that does not include wheels.

The apparatus body 1 is connected to a communication network N such as an in-hospital local area network (LAN) via an access point (AP) 20 installed in a hospital, for example, by wireless communication. The apparatus body 1 is capable of transmitting and receiving data to and from an external apparatus via the communication network N. Here, the external apparatus is, for example, a radiology information systems (RIS) 30, a picture archiving and communication system (PACS) 40, an analysis apparatus 50, or the like.

The radiographic imaging apparatus 10 performs radiation irradiation from the radiation source 2 in a state where the FDP 3 is disposed at a position opposite to the radiation source 2 with a subject H (patient) therebetween, and captures a radiographic image (a still image or a dynamic image) of the subject H.

In the present embodiment, the dynamic imaging refers to acquiring a plurality of images of the subject H by repeatedly irradiating the subject H with pulsed radiation, where the radiation is X-rays or the like, at predetermined time intervals (pulse irradiation). A series of images obtained by dynamic imaging is referred to as dynamic image. Further, a dynamic image is constituted by a plurality of frame images. In contrast, a still image is constituted by one frame image. Hereinafter, the still image and the dynamic image may be collectively referred to as a radiographic image or an image.

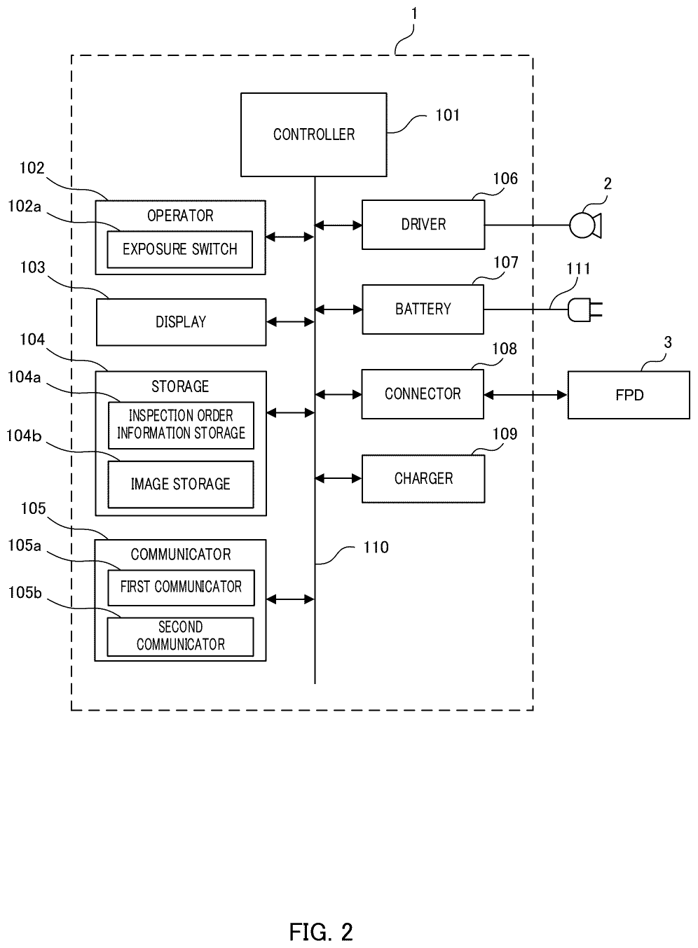

FIG. 2 is a block diagram illustrating a functional configuration of the apparatus body 1.

The apparatus body 1 has a function as a console (imaging control apparatus) and also functions as a computer. As illustrated in FIG. 2, the apparatus body 1 includes a controller 101, an operator 102, a display 103, a storage 104, a communicator 105, a driver 106, a battery 107, a connector 108, a charger 109, and the like. Each section of the apparatus body 1 is connected by a bus 110.

In the radiographic imaging apparatus 10, the radiation source 2, the FDP 3, the controller 101, the communicator 105, the driver 106, and the like correspond to the imager in the present invention that performs irradiation of radiation and performs still image capturing and dynamic image capturing.

The controller 101 is, for example, a computer including at least one hardware processor, and is constituted by a central processing unit (CPU), a random access memory (RAM), and the like. The radiographic imaging program is stored in a non-transitory computer-readable recording medium, and the storage 104 stores the radiographic imaging program from the recording medium. In response to an input through the operator 102, the CPU reads out a system program and various processing programs stored in the storage 104, develops the system program and various processing programs in the RAM, and executes various pieces of processing according to the developed programs.

As will be described later, the controller 101 controls the imager of the radiographic imaging apparatus 10 such that the imager operates in an intermittent imaging mode (the first imaging mode in the present invention) in which the imager performs radiographic imaging a plurality of times between the start of an operation of the imager and the end of the operation of the imager according to one imaging order. In the present embodiment, the imaging order will be referred to as a main imaging order. The main imaging order corresponds to the imaging instruction in the present invention. Further, a main imaging order ID to be described later, which corresponds to the main imaging order, is an example of the information on the imaging instruction in the present invention.

Further, as will be described later, the controller 101 changes (increases or decreases) the number of times of imaging in the intermittent imaging mode based on the main imaging order for instructing the intermittent imaging mode. Further, as will be described later, the controller 101 determines whether an increase in the intermittent imaging mode is allowed, and increases the number of times of imaging in a case where an increase is allowed.

As will be described later, the controller 101 sets, in association with the main imaging order, sub-imaging orders that respectively correspond to the number of times of imaging in the intermittent imaging mode. Further, in a case where the main imaging order is deleted, the controller 101 also deletes the sub-imaging orders associated with the main imaging order. The sub-imaging order corresponds to the sub-imaging instruction in the present invention. Further, a sub-imaging order ID to be described later, which corresponds to the sub-imaging order, is an example of the information on the sub-imaging instruction in the present invention.

The operator 102 includes a touch screen or the like in which transparent electrodes are arranged in a lattice shape so as to cover the surface of the display 103. The touch screen detects a position pressed with a finger, a touch pen, or the like, and inputs information of the position as operation information to the controller 101. Further, the operator 102 includes an exposure switch 102a. The exposure switch 102a is a switch for the user to instruct radiation irradiation with the radiation source 2 and imaging.

The display 103 is constituted by a monitor such as a liquid crystal display (LCD) or a cathode ray tube (CRT). The display 103 performs display according to an instruction of a display signal input from the controller 101.

The storage 104 is constituted by a non-volatile semiconductor memory, a hard disk, or the like. The storage 104 stores various programs to be executed by the controller 101, parameters required for execution of processing by the programs, data of processing results, and the like.

Further, in the present embodiment, the storage 104 is provided with an inspection order information storage 104a, an image storage 104b, and the like.

The inspection order information storage 104a stores information on an inspection order acquired from the RIS 30. The inspection order includes, for example, patient information and inspection information. The patient information includes, for example, the patient ID, name, gender, age, hospital room (ward), and the like of the patient to be examined. The inspection information includes an inspection ID, an inspection date, and one or more main imaging orders to be performed in the inspection. The main imaging order includes an imaging region, an imaging direction, a type of imaging (still image capturing, moving object imaging, intermittent imaging), and the like, and is represented by an RIS code.

The RIS code is a code (integer string) for causing the radiographic imaging apparatus 10, the RIS 30, the PACS 40, the analysis apparatus 50, and the like to cooperate in the radiology department. The RIS code is generally constituted by a procedure code portion (modality, large classification, small classification, procedure extension, and the like), a region code portion (small region, right and left, and the like), and an imaging code portion (posture, body position, imaging direction, and the like). In the present embodiment, the RIS code may include a code corresponding to a preset for sub-imaging orders to be described later.

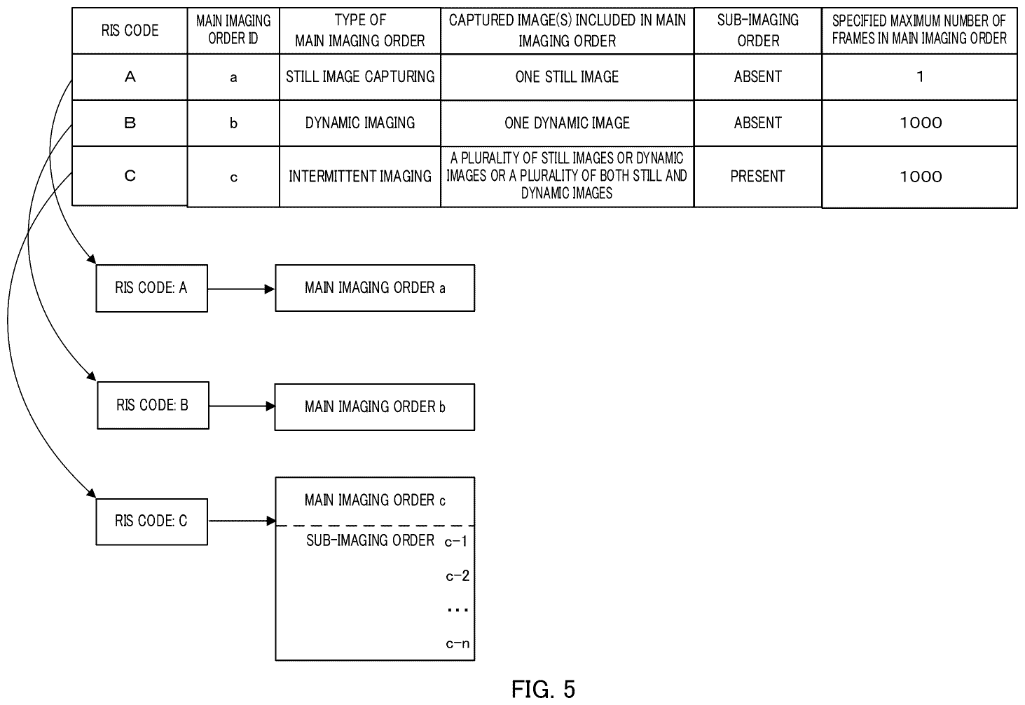

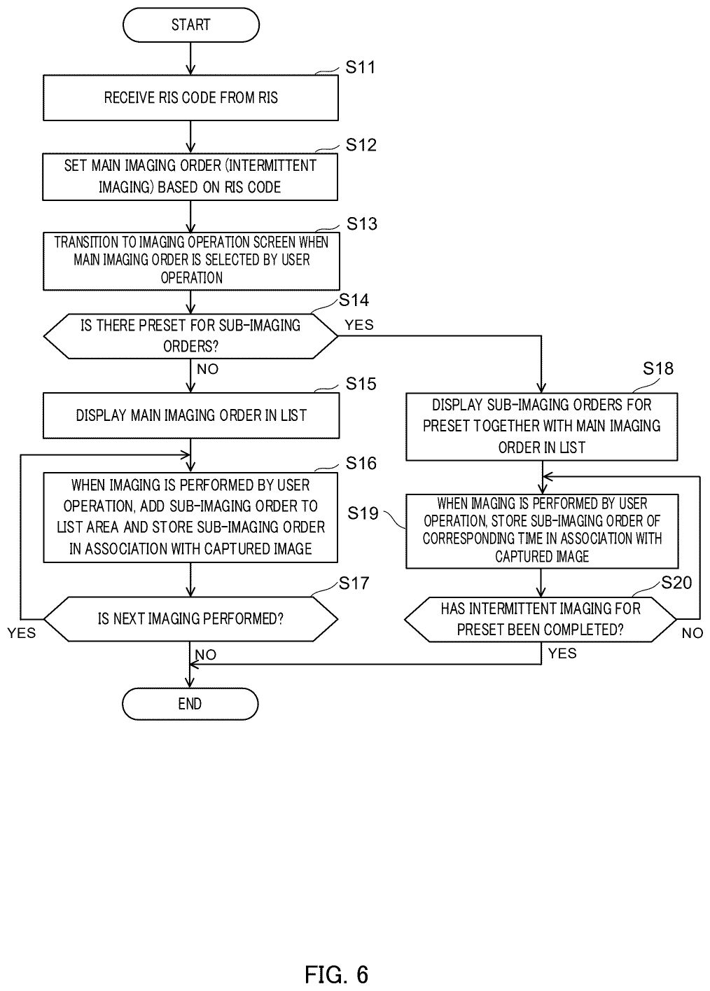

In the present embodiment, as will be described later with reference to FIG. 6, the radiographic imaging apparatus 10 sets the main imaging order based on the RIS code of the inspection order. Although there is a case where a plurality of main imaging orders is set based on the RIS code, it is assumed in the present embodiment that one main imaging order is set based on the RIS code for the sake of simplifying the description. In addition, in the present embodiment, the radiographic imaging apparatus 10 has the intermittent imaging mode as the imaging mode, and thus, it is configured such that a plurality of sub-imaging orders is set together with the main imaging order based on the RIS code corresponding to the intermittent imaging mode. The main imaging order and the sub-imaging orders will be described later with reference to FIG. 5.

Note that, the main imaging order and the sub-imaging orders are not necessarily set based on the RIS code, but may be set by the user directly inputting through the operator 102 or the like, for example.

The image storage 104b (the storage in the present invention) stores a radiographic image, which has been transferred from the FDP 3, in association with supplementary information. The supplementary information is, for example, patient information or the like. Further, in the present embodiment, the supplementary information also includes information on the main imaging order (main imaging order ID) and information on the sub-imaging order (sub-imaging order ID) associated with the main imaging order. In other words, the image storage 104b stores a plurality of sub-imaging orders (sub-imaging order IDs) in association with radiographic images, respectively, where the radiographic images have been captured with the number of times of imaging corresponding to the plurality of sub-imaging orders. As a result, the image storage 104b stores the main imaging order (main imaging order ID) in association with the radiographic images for the plurality of times which have been captured with the sub-imaging orders associated with the main imaging order. By such association, the radiographic images for the plurality of times which have been captured in response to the sub-imaging orders are processed (managed, displayed, analyzed, and/or the like) in association with the main imaging order (main imaging order ID).

The communicator 105 includes a first communicator 105a and a second communicator 105b. The first communicator 105a performs data transmission and reception to and from the FDP 3 by wired communication or wireless communication. The second communicator 105b performs data transmission and reception to and from an external apparatus such as the RIS 30 or the PACS 40 connected to the communication network N via the AP 20.

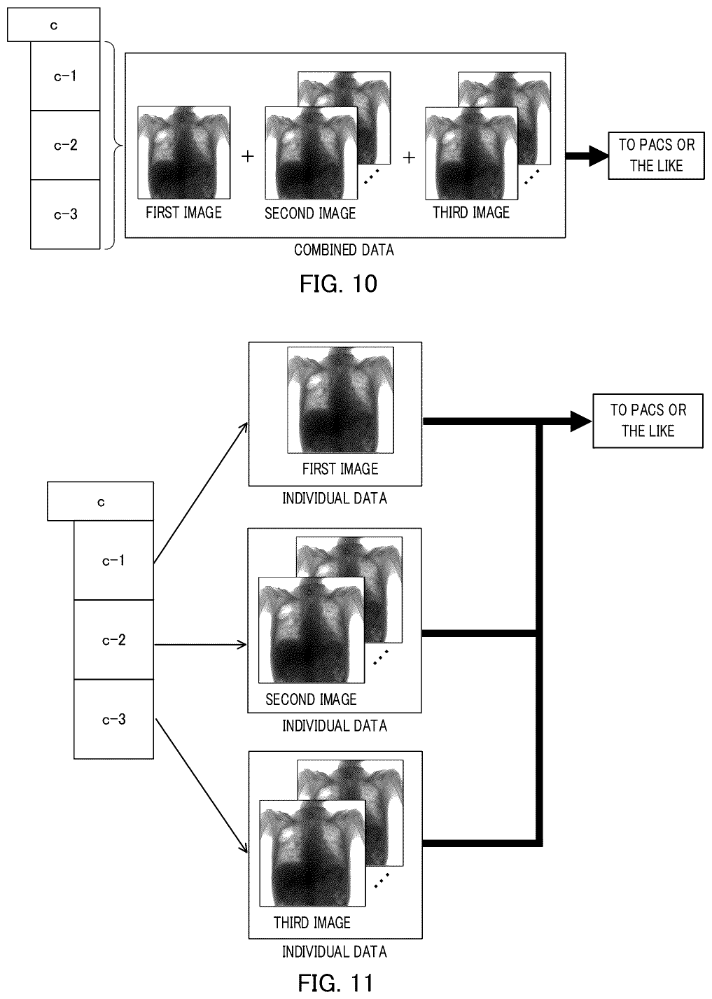

The second communicator 105b functions as an outputter that outputs data to an external apparatus. In this case, for example, as will be described later with reference to FIGS. 10 and 11, the radiographic images captured by a plurality of times of imaging, which are associated with the main imaging order (main imaging order ID), are output for each main imaging order (main imaging order ID) or for each sub-imaging order (sub-imaging order ID).

The driver 106 is a circuit that drives the tube of the radiation source 2. The driver 106 and the radiation source 2 are connected to each other via a cable.

The battery 107 supplies electric power to each section of the apparatus body 1 and the radiation source 2. The battery 107 can be charged from the outside via an AC cable 111.

The connector 108 is provided inside an accommodator 120 and is electrically connected to the FDP 3 accommodated in the accommodator 120.

The charger 109 charges the FDP 3, which is connected to the charger 109 via the connector 108, with electric power supplied from the battery 107 based on the control of the controller 101.

The radiation source 2 is driven by the driver 106 and irradiates the subject H with radiation (X-rays). In the case of dynamic imaging, for example, the radiation source 2 repeatedly irradiates the subject H with pulsed radiation at predetermined time intervals.

The FDP 3 is a portable radiation detector that is compatible with still image capturing and dynamic imaging, and various known FPDs can be used. In addition, the radiation irradiation from the radiation source 2 and the radiographic imaging using the FDP 3 are configured to be synchronized with each other by known synchronization control, for example, by time correction using time synchronization communication.

The FDP 3 includes, for example, radiation detection elements that are two-dimensionally arranged on a glass substrate. The radiation detection element is constituted by a semiconductor image sensor such as a photodiode. The radiation detection element detects radiation, which has been irradiated from the radiation source 2 and transmitted through at least the subject H, according to the intensity of the radiation, converts the detected radiation into an electrical signal, and accumulates the electrical signal. For example, a switch such as a thin film transistor (TFT) is connected to each radiation detection element, the switch controls the accumulation and reading of electrical signals, and image data is acquired.

The RIS 30 issues and stores an inspection order. Further, the RIS 30 transmits the issued inspection order to the apparatus body 1 or the like of the radiographic imaging apparatus 10 via the communication network N.

The PACS 40 stores and manages a medical image (a radiographic image or the like), which is generated by a modality such as the radiographic imaging apparatus 10, in association with supplementary information (patient information, inspection information, or the like) of the medical image.

The analysis apparatus 50 analyzes a medical image generated by the modality such as the radiographic imaging apparatus 10, and outputs an analysis result.

### [Imaging Operations in Radiographic Imaging Apparatus]

Next, imaging operations in the radiographic imaging apparatus 10 in the present embodiment will be described. The radiographic imaging apparatus 10 has still image capturing, in which a still image is captured, and dynamic imaging as imaging operations.

In the dynamic imaging in the related art, pulse irradiation from the radiation source 2 is continuously performed between the start of one imaging and the end of the imaging to acquire a dynamic image constituted by a series of a plurality of frame images. However, in imaging outside the imaging room, the cumulative dose of radiation that can be irradiated between the start of one imaging and the end of the imaging is limited from the viewpoint of risk management, and pulse irradiation for a long time cannot be performed. For this reason, for example, in a case where it is checked with dynamic imaging how a treatment of catheter insertion is like or in a case where a situation in a body immediately after administration of a contrast agent is checked with dynamic imaging, imaging cannot be performed for a long time, and thus, an image at a necessary timing may not be obtained.

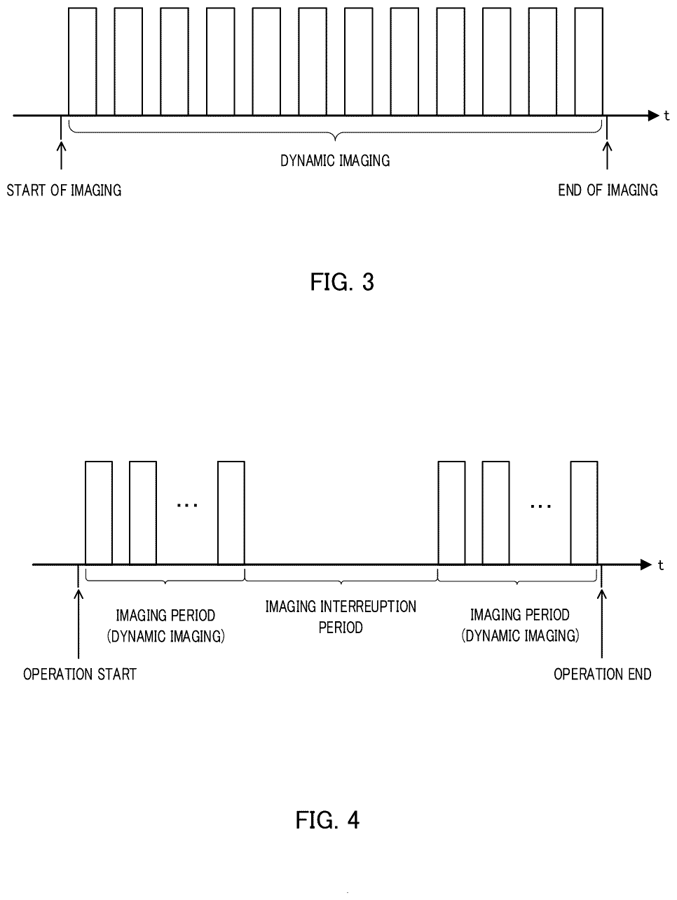

Accordingly, the radiographic imaging apparatus 10 in the present embodiment has a normal mode and an intermittent imaging mode as operation modes for dynamic imaging. FIG. 3 is a diagram schematically illustrating pulse irradiation in the normal mode. FIG. 4 is a diagram schematically illustrating pulse irradiation in the intermittent imaging mode.

The normal mode (an example of the second imaging mode in the present invention) is a mode in which dynamic imaging similar to that in the related art is performed. As illustrated in FIG. 3, the normal mode is a mode in which pulse irradiation from the radiation source 2 is continuously performed between the start of one imaging and the end of the imaging. As described above, the normal mode is a mode in which a dynamic image is captured once. In the normal mode, one dynamic image constituted by a series of a plurality of frame images is obtained. Note that, still image capturing (an example of the second imaging mode in the present invention) is a mode in which a still image is captured once. In the still image capturing, one still image constituted by one frame image is obtained.

As illustrated in FIG. 4, the intermittent imaging mode is a mode in which there are an imaging period and an imaging interruption period between the start of one operation and the end of the operation and dynamic imaging, in which pulse irradiation from the radiation source 2 is continuously performed, is intermittently performed a plurality of times. In the intermittent imaging mode, dynamic images each of which is constituted by a series of a plurality of frame images are obtained for a plurality of times. The intermittent imaging mode may include not only dynamic imaging, but may also include still image capturing. In the intermittent imaging mode, each of a plurality of times of imaging (a plurality of times of imaging including one or both of still image capturing and dynamic imaging) will be referred to as intermittent imaging. In the present embodiment, the start of the operation of the intermittent imaging mode will be referred to as operation start, the end of the operation of the intermittent imaging mode will be referred to as operation end, and a period from the operation start to the operation end will be referred to as an operation period. Further, the start of one intermittent imaging will be referred to as an intermittent imaging start, and the end thereof will be referred to as an intermittent imaging end.

Further, in the present embodiment, the radiographic imaging apparatus 10 sets a main imaging order and sub-imaging orders based on the inspection order (RIS code) transmitted from the RIS 30. FIG. 5 is a diagram describing a main imaging order and sub-imaging orders.

The inspection order includes the RIS code as described above. Here, for description, the RIS codes corresponding to the still image capturing, the dynamic imaging, and the intermittent imaging are denoted by A, B, and C, respectively. The radiographic imaging apparatus 10 sets the main imaging order ID based on the RIS code of the inspection order transmitted from the RIS 30. Here, the main imaging order IDs corresponding to the RIS codes A, B, and C are defined as a, b, and c, respectively.

As illustrated in FIG. 5, the main imaging order ID corresponding to the RIS code A is a. The imaging corresponding to the main imaging order ID: a is still image capturing. Accordingly, there is no sub-imaging order in the main imaging order of the main imaging order ID: a, and the specified maximum number of frames in the main imaging order is one. Accordingly, the radiographic imaging apparatus 10 sets the main imaging order ID: a based on the RIS code transmitted from the RIS 30. Then, the radiographic imaging apparatus 10 performs still image capturing, in which one still image is captured, in response to the main imaging order of the main imaging order ID: a, and stores the captured one still image in association with the main imaging order ID: a.

Further, as illustrated in FIG. 5, the main imaging order ID corresponding to the RIS code B is b. The imaging corresponding to the main imaging order ID: b is dynamic imaging. Accordingly, the main imaging order of the main imaging order ID: b does not include the sub-imaging order, and the specified maximum number of frames in the main imaging order is 1000. Accordingly, the radiographic imaging apparatus 10 sets the main imaging order ID: b based on the RIS code transmitted from the RIS 30. Then, the radiographic imaging apparatus 10 performs dynamic imaging, in which one dynamic image is captured, in response to the main imaging order of the main imaging order ID: b, and stores the captured one dynamic image in association with the main imaging order ID: b.

Further, as illustrated in FIG. 5, the main imaging order ID corresponding to the RIS code C is c. The imaging corresponding to the main imaging order ID: c is intermittent imaging. Accordingly, the main imaging order of the main imaging order ID: c includes sub-imaging orders, and the specified maximum number of frames in the main imaging order is 1000. Accordingly, the radiographic imaging apparatus 10 sets the main imaging order ID: c based on the RIS code transmitted from the RIS 30, and further sets the sub-imaging orders ID: c-1 to c-n, and n is the number of times of sub-imaging orders and, as will be described with FIG. 6, increases or decreases by a preset or the number of times of imaging repeated by the user. Then, the radiographic image imaging apparatus 10 performs intermittent imaging (still image capturing or dynamic imaging) corresponding to each of the sub-imaging orders ID: c-1 to c-n, and stores a plurality of captured images in association with the sub-imaging orders ID: c-1 to c-n, respectively.

Note that, since the main imaging order of the main imaging order ID: c includes a plurality of sub-imaging orders, the specified maximum number of frames in each of the plurality of sub-imaging orders may be set in addition to the specified maximum number of frames in the main imaging order.

As described above, the main imaging order of the main imaging order ID: c includes the sub-imaging orders of the sub-imaging orders ID: c-1 to c-n, and the sub-imaging orders ID: c-1 to c-n are associated with corresponding images, respectively. Accordingly, the radiographic imaging apparatus 10 processes the images associated with the sub-imaging orders ID: c-1 to c-n, respectively, as a series of images associated with the main imaging order ID: c of one main imaging order, for example, outputs the images to an external apparatus such as the PACS 40. Then, even the external apparatus such as the PACS 40 processes (manages, displays, analyzes, and/or the like) the respective images associated with the sub-imaging orders ID: c-1 to c-n as a series of images associated with the main imaging order ID: c of one main imaging order.

Accordingly, in the present embodiment, the sub-imaging orders ID: c-1 to c-n are set in response to the main imaging order of the main imaging order ID: c, and are associated with corresponding images, respectively, and thus, subsequent processing is facilitated, and the operability thereof improves.

### [Radiographic Imaging Method in Radiographic Imaging Apparatus]

A radiographic imaging method which is performed by the radiographic imaging apparatus 10 will be described with reference to FIGS. 1 to 5 and also FIG. 6. FIG. 6 is a flowchart illustrating a radiographic imaging method which is performed by the radiographic imaging apparatus 10. The radiographic imaging method is performed by the controller 101 executing a radiographic imaging program stored in the storage 104.

### (Step S11)

The controller 101 receives an inspection order including an RIS code from the RIS 30. The inspection order is issued at the RIS 30 as described above. The issued inspection order is then transmitted from the RIS 30 to the controller 101 via the communication network N, the AP 20, and the second communicator 105b, and is stored in the inspection order information storage 104a.

### (Step S12)

The controller 101 sets the main imaging order based on the RIS code. Here, since a case where the RIS code is C will be described, the main imaging order ID: c is set as the main imaging order.

### (Step S13)

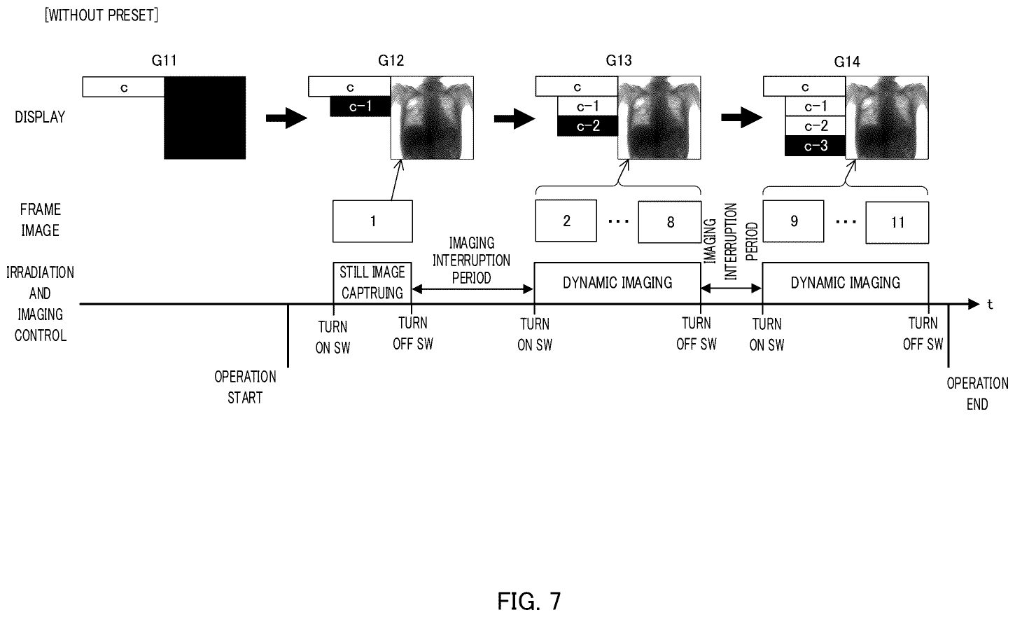

When the main imaging order (main imaging order ID: c) is selected by a user operation, the controller 101 transitions to an imaging operation screen. The controller 101 transitions to, for example, a screen G11 illustrated in FIG. 7 to be described later.

### (Step S14)

The controller 101 checks whether there is a preset for sub-imaging orders. The code corresponding to the preset is included in, for example, the RIS code as described above, and the controller 101 checks the presence or absence of a preset by referring to the RIS code. Note that, the RIS code may not include a code corresponding to a preset. In that case, the controller 101 checks the presence or absence of a preset by referring to the preset setting on the side of the radiographic imaging apparatus 10 associated with the main imaging order. As described above, the presence or absence of a preset is checked, and in a case where there is no preset (NO), the processing proceeds to step S15 and in a case where there is a preset (YES), the processing proceeds to step S18.

### (Step S15)

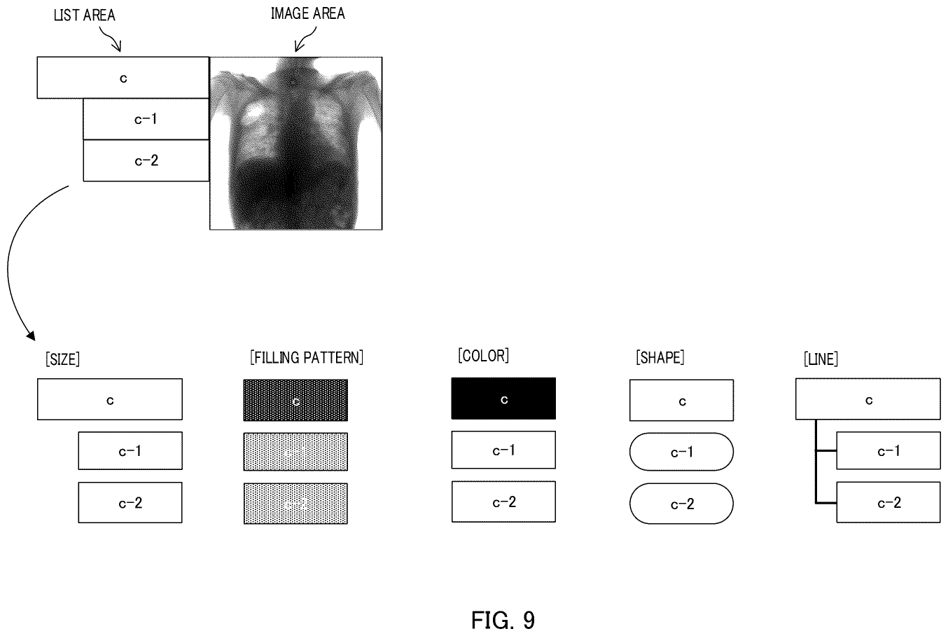

In a case where it is determined in step S14 that there is no preset (NO), the controller 101 causes the main imaging order to be displayed in a list area (see FIG. 9 to be described later). Here, since the main imaging order is ID: c, the main imaging order ID: c is displayed in the list area as illustrated in the screen G11 of FIG. 7.

### (Step S16)

When imaging is performed by a user operation, the controller 101 adds a sub-imaging order to the list area, associates the sub-imaging order with the captured image, and stores the sub-imaging order and the captured image in the image storage 104b. For example, as illustrated in a screen G12 of FIG. 7, the sub-imaging order ID: c-1 is added to the list area, and the sub-imaging order ID: c-1 is associated with the captured still image. At this time, the controller 101 turns on the exposure switch 102a to start the intermittent imaging, and turns off the exposure switch 102a to end the intermittent imaging. The selection between the still image capturing and the dynamic imaging in the intermittent imaging can be performed, for example, by a quick press, a long press, or the like on the exposure switch 102a.

Note that, the addition of a sub-imaging order may be performed at the start of intermittent imaging, during intermittent imaging, or at the end of intermittent imaging, or may be performed after the first communicator 105a receives all images after the end of intermittent imaging.

### (Step S17)

The controller 101 checks whether the next imaging is performed. The controller 101 monitors, for example, the exposure switch 102a for a predetermined time, and determines that the next imaging is performed when the exposure switch 102a is turned on, and determines that the next imaging is not performed when the exposure switch 102a is not turned on. In a case where the next imaging is performed (YES), the processing returns to step S16, whereas in a case where the next imaging is not performed (NO), the series of processing ends.

The controller 101 repeats steps S16 and S17 with the imaging interruption period interposed until the controller 101 determines that the next imaging is not performed. For example, as illustrated in screens G13 and G14 of FIG. 7, the sub-imaging orders ID: c-2 and c-3 are sequentially added to the list area, and the sub-imaging orders ID: c-2 and c-3 and the dynamic images captured with the respective sub-imaging orders are associated with each other and stored in the image storage 104b.

### (Step S18)

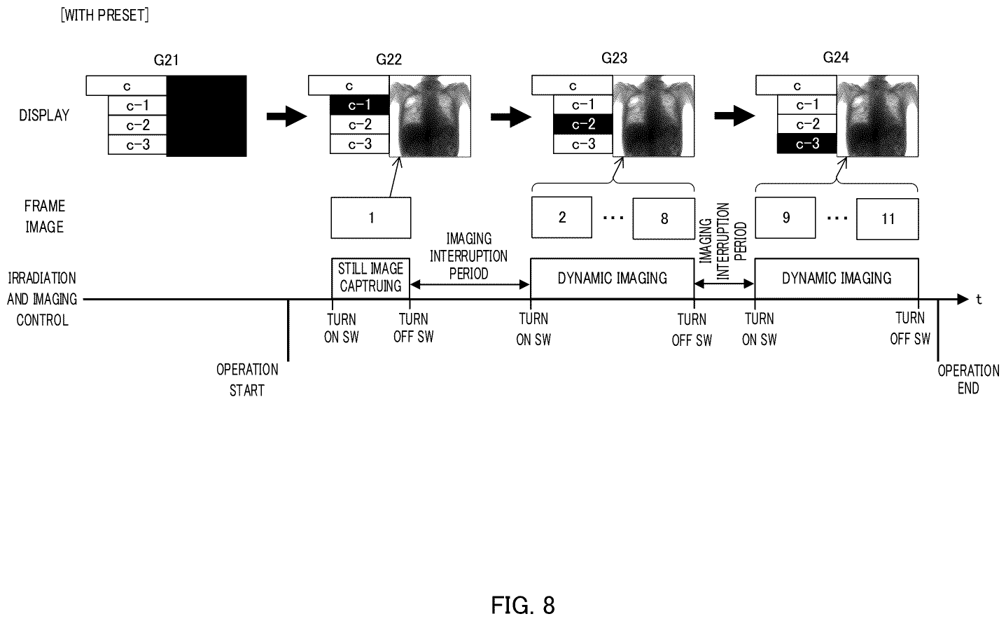

In a case where it is determined in step S14 that there is a preset (YES), the controller 101 causes the sub-imaging orders for the preset together with the main imaging order to be displayed in the list area. Here, since the main imaging order is ID: c and the sub-imaging orders are ID: c-1 to c-3, the main imaging order ID: c and the sub-imaging orders ID: c-1 to c-3 are displayed in the list area, as illustrated in a screen G21 of FIG. 8 to be described later.

### (Step S19)

When imaging is performed by a user operation, the controller 101 associates the sub-imaging order of the corresponding time with the captured image and stores the sub-imaging order and the captured image in the image storage 104b. For example, in the case of the first sub-imaging order, as illustrated in a screen G22 of FIG. 8, the sub-imaging order ID: c-1 is associated with the captured still image.

### (Step S20)

The controller 101 checks whether the intermittent imaging for the preset has been completed. In a case where the intermittent imaging for the preset has been completed (YES), the series of processing ends, whereas in a case where the intermittent imaging for the preset has not been completed (NO), the processing returns to step S19.

The controller 101 repeats steps S19 and S20 with the imaging interruption period interposed until the intermittent imaging for the preset has been completed. For example, when there are the second and third sub-imaging orders, as illustrated in screens G23 and G24 of FIG. 8, the sub-imaging orders ID: c-2 and c-3 and the dynamic images captured with the respective sub-imaging orders are associated with each other and stored in the image storage 104b.

As described above, in the present embodiment, in a case where imaging is performed on a patient a plurality of times within one operation period according to one main imaging order, the main imaging order ID of the main imaging order and the sub-imaging order IDs of a plurality of sub-imaging orders are stored in association with each other. Further, the sub-imaging order IDs of a plurality of sub-imaging orders and images captured with the respective sub-imaging orders are stored in association with each other. Thus, images associated with the sub-imaging order IDs of a plurality of sub-imaging orders, respectively, can be processed (managed, displayed, analyzed, and/or the like) as a series of images associated with the main imaging order ID of one main imaging order.

The present embodiment is in particular suitable for a case where the number of times of imaging is variable. For example, the present embodiment is suitable for a case where the number of times of imaging during one operation period is changed according to a situation of treatment on a patient or a state of the patient.

Here, the radiographic imaging method illustrated in FIG. 6 will be described with respect to a case where there is no preset for sub-imaging orders. FIG. 7 is a diagram which schematically describes the radiographic imaging method illustrated in FIG. 6, and which describes a case where there is no preset for sub-imaging orders. The diagram illustrated in FIG. 7 corresponds to steps S15 to S17 in the radiographic imaging method illustrated in FIG. 6.

In a case where there is no preset for sub-imaging orders, the controller 101 causes the display 103 to display the screen G11 to display the main imaging order ID: c in the list area.

An operation in one operation period according to one main imaging order is started by a user operation. The operation start is, for example, a timing at which both the radiation source 2 and the FDP 3 become ready after the selection of the main imaging order (intermittent imaging) and the controller 101 allows irradiation of X-rays. Further, the user turns on the exposure switch 102a to start intermittent imaging, and turns off the exposure switch 102a to end the intermittent imaging.

With the sub-imaging order of the first sub-imaging order ID: c-1, for example, still image capturing is performed for positioning. In this case, as illustrated in the screen G12, the controller 101 causes the sub-imaging order ID: c-1 to be displayed in the list area thereof. The still image capturing may not be performed if not necessary, or may be performed a plurality of times if necessary.

Then, the controller 101 associates the sub-imaging order ID: c-1 added to the list area with the captured still image (here, a frame image 1), and stores the sub-imaging order ID: c-1 and the captured still image in the image storage 104b. Further, as illustrated in the screen G12, the controller 101 causes the still image (the frame image 1) to be displayed in the image area thereof (see FIG. 9 to be described later).

Thereafter, an imaging interruption period comes until the user next turns on the exposure switch 102a.

Next, it is assumed that the user turns on and off the exposure switch 102a and, for example, dynamic imaging is performed. In this case, as illustrated in the screen G13, the controller 101 causes the sub-imaging order ID: c-2 to be displayed in the list area thereof. Then, the controller 101 associates the sub-imaging order ID: c-2 added to the list area with the captured dynamic images (here, frame images 2 to 8) and stores the sub-imaging order ID: c-2 and the captured dynamic images in the image storage 104b. In addition, as illustrated in the screen G13, the controller 101 causes the dynamic images (the frame images 2 to 8) to be displayed in the image area thereof.

Thereafter, the imaging interruption period comes until the user next turns on the exposure switch 102a, and the next imaging is performed when the user turns on and off the exposure switch 102a (see the screen G14). On the other hand, for example, the timing, at which addition of a sub-imaging order is not allowed or the user performs an end operation, is the operation end, and the operation ends at this timing.

Note that, in the example illustrated in FIG. 7, it is configured such that while each sub-imaging order is being executed, the sub-imaging order that is being executed is allowed to be visually recognized by the user as illustrated in the list areas of the screens G12 to G14. For example, it is configured such that in the list area, the color or the like of the area of the sub-imaging order that is being executed is different from those of the other areas or the area flashes. In addition, the frame numbers of frames that have been captured or the number of frames that have been captured may be displayed in the screen area.

Next, the radiographic imaging method illustrated in FIG. 6 will be described for a case in which there is a preset for sub-imaging orders. FIG. 8 is a diagram which schematically describes the radiographic imaging method illustrated in FIG. 6, and which describes a case where there is a preset for sub-imaging orders. The diagram illustrated in FIG. 8 corresponds to steps S18 to S20 in the radiographic imaging method illustrated in FIG. 6.

In a case where there is a preset for sub-imaging orders, the controller 101 causes the display 103 to display the screen G21 to display the sub-imaging orders ID: c-1 to c-3 of the sub-imaging orders for the present together with the main imaging order ID: c in the list area thereof.

An operation in one operation period according to one main imaging order is started by a user operation, intermittent imaging is further started by the user turning on the exposure switch 102a, and intermittent imaging is completed by the user turning off the exposure switch 102a.

For example, in the sub-imaging order of the first sub-imaging order ID: c-1, a still image is captured for positioning. The controller 101 associates the sub-imaging order ID: c-1 with the captured still image (here, the frame image 1), and stores the sub-imaging order ID: c-1 and the captured still image in the image storage 104b. Further, as illustrated in the screen G22, the controller 101 causes the still image (the frame image 1) to be displayed in the image area thereof.

Thereafter, an imaging interruption period comes until the user next turns on the exposure switch 102a.

Next, it is assumed that the user turns on and off the exposure switch 102a and, for example, dynamic imaging is performed. In this case, as illustrated in the screen G23, the controller 101 associates the sub-imaging order ID: c-2 with the captured dynamic images (here, the frame images 2 to 8), and stores the sub-imaging order ID: c-2 and the captured dynamic images in the image storage 104b. In addition, as illustrated in the screen G23, the controller 101 causes the dynamic images (the frame images 2 to 8) to be displayed in the image area thereof.

Thereafter, the imaging interruption period comes until the user next turns on the exposure switch 102a, and the next imaging is performed when the user turns on and off the exposure switch 102a (see the screen G24). On the other hand, for example, when the imaging of the sub-imaging orders for the preset ends or the user performs an end operation, the operation ends at this timing.

Note that, even in the example illustrated in FIG. 8, as in the example illustrated in FIG. 7, it is configured such that while each sub-imaging order is being executed, the sub-imaging order that is being executed is allowed to be visually recognized by the user as illustrated in the screens G22 to G24.

Further, the main imaging order and the sub-imaging orders may also be configured such that the user is allowed to visually distinguish between the main imaging order and the sub-imaging orders displayed in the list area. FIG. 9 is a diagram illustrating an exemplary distinguished display of a main imaging order and sub-imaging orders. For example, as illustrated in FIG. 9, in the list area of the main imaging order and the sub-imaging orders, the sizes, the filling patterns, the colors, the shapes, and the like are made different from each other, and thus, the user is allowed to visually distinguish between the main imaging order and the sub-imaging orders. This is feasible by the controller 101 controlling the display 103.

For example, it is configured such that the sizes of the areas of sub-imaging orders are made smaller than that of the main imaging order, thereby allowing the user to distinguish between the main imaging order and the sub-imaging orders. Further, the filling patterns of the areas for the sub-imaging orders are made rougher than that for the main imaging order, thereby allowing the user to distinguish between the main imaging order and the sub-imaging orders. Further, the colors for the areas of the main imaging order and the sub-imaging orders are made different from each other, thereby allowing the user to distinguish between the main imaging order and the sub-imaging orders. Further, the shapes for the areas of the main imaging order and the sub-imaging orders are made different from each other, thereby allowing the user to distinguish between the main imaging order and the sub-imaging orders.

Further, the sub-imaging orders may be displayed using lines in a tree structure in which the sub-imaging orders are connected below the main imaging order, thereby allowing the user to distinguish between the main imaging order and the sub-imaging orders.

Further, as in a folding display function of known spreadsheet software, all or some of sub-imaging orders may be temporarily hidden, and only the main imaging order or only the main imaging order and necessary sub-imaging orders may be displayed. For example, a sub-imaging order that does not need to be always displayed, such as a still image for positioning check, is temporarily not displayed.

In this way, since the user can distinguish between the main imaging order and the sub-imaging orders, the user can operate the apparatus without reducing operability.

[Output Data from Radiographic Imaging Apparatus]

As described above, in the present embodiment, one main imaging order includes a plurality of sub-imaging orders, and each of the plurality of sub-imaging orders is associated with a corresponding image and stored in the image storage 104b.

As described above, in the present embodiment, one main imaging order is associated not with one image (still image or dynamic image) captured by one imaging, but with a plurality of images (a plurality of images including either still images or dynamic images or including both of still and dynamic images) captured by a plurality of times of imaging.

Accordingly, as illustrated in FIGS. 10 and 11, the controller 101 combines and outputs a plurality of images or individually outputs a plurality of images, and transmits the images to an external apparatus such as a PACS.

FIG. 10 is a diagram describing an example in which captured images of a plurality of sub-imaging orders included in a main imaging order are combined into one and output to an external apparatus. FIG. 11 is a diagram describing an example in which captured images of a plurality of sub-imaging orders included in a main imaging order are individually output to an external apparatus.

For example, in FIGS. 10 and 11, it is assumed that a still image is associated with the sub-imaging order ID: c-1 and dynamic images are associated with the sub-imaging orders ID: c-2 and c-3.

In the case of the example illustrated in FIG. 10, the controller 101 creates combined data obtained by combining the still image associated with the sub-imaging order ID: c-1 and the dynamic images associated with the sub-imaging orders ID: c-2 and c-3 into one. That is, the combined data is a multi-frame image. Then, the controller 101 transmits the created combined date as output data corresponding to the main imaging order ID: c to an external apparatus such as a PACS for each main imaging order ID. At this time, the combined data is associated with information similar to a digital image and communications in medicine (DICOM) image (for example, patient information, inspection information, or the like). Accordingly, an external apparatus such as a PACS can treat the combined data substantially equivalently to a conventional one dynamic image.

On the other hand, in the case of the example illustrated in FIG. 11, the controller 101 keeps the still image associated with the sub-imaging order ID: c-1 and the dynamic images associated with the sub-imaging orders ID: c-2 and c-3 as individual images, respectively. In the individual data, the still image remains as a single-frame image, and the dynamic image remains as a multi-frame image. Then, the controller 101 transmits the individual data as output data corresponding to the main imaging order ID: c to an external apparatus such as a PACS for each sub-imaging order-ID. At this time, the individual data is associated with information similar to a DICOM image, and is further associated with series information indicating the same main imaging order ID: c. The external apparatus such as a PACS handles the individual image as one conventional still image or one conventional dynamic image, but can handle the individual image as data according to one main imaging order since the series information indicating the same main imaging order ID: c is associated.

### <Modifications>

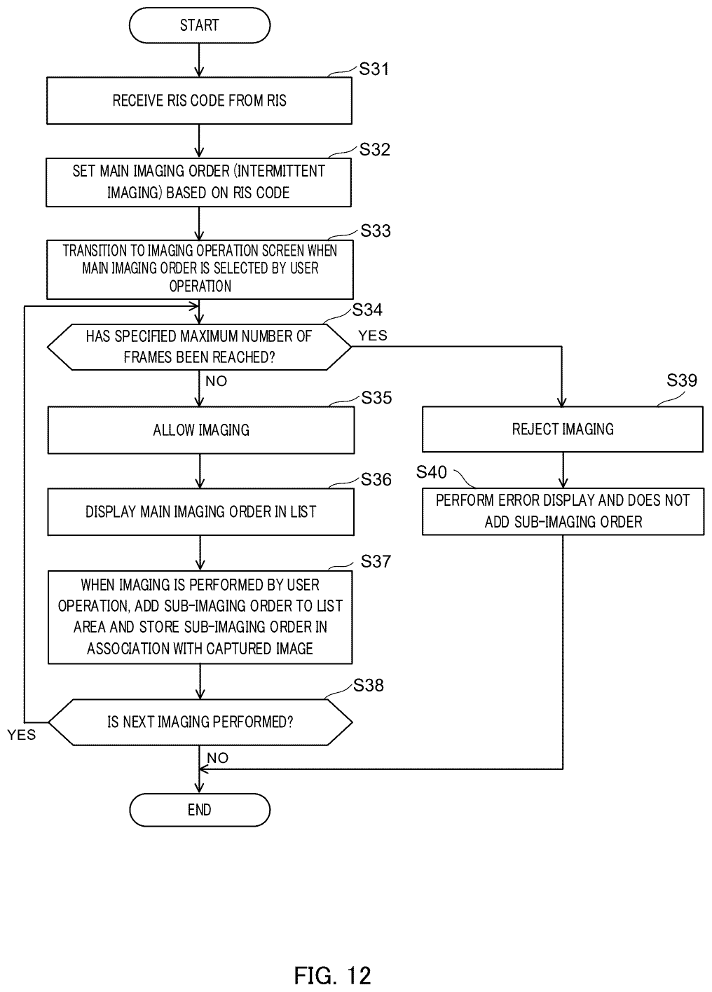

In the radiographic imaging method illustrated in FIG. 6, the addition of a sub-imaging order is not prohibited, but the addition of a sub-imaging order may be prohibited from the viewpoint of radiation exposure management in a case where imaging is performed a plurality of times not in an imaging room of a hospital but at places where a doctor's hospital rounds take place, or the like. Such a case will be described with reference to FIG. 12.

FIG. 12 is a flowchart describing a radiographic imaging method which is performed by the radiographic imaging apparatus, and which includes determination of allowing imaging to be added. Note that, also here, the case where the RIS code is C will be described. In addition, here, description will be given on the assumption that there is no preset for sub-imaging orders.

### (Steps S31 to S33)

Steps S31 to S33 are the same as steps S11 to S13 described in the flowchart illustrated in FIG. 6, and therefore, description thereof is omitted here.

Here, although it is assumed that there is no preset for sub-imaging orders as described above, the presence or absence of a preset may be determined as described in step S14 of the flowchart illustrated in FIG. 6. Then, in a case where there is a preset for sub-imaging orders, the following determination of allowing imaging to be added may be performed when a sub-imaging order is further added in addition to the sub-imaging orders for the preset.

### (Step S34)

The controller 101 checks whether the number of frames captured with the currently executed main imaging order has reached the specified maximum number of frames. The controller 101 manages, for example, the number of captured frames and the specified maximum number of frames in a management table. In a case where the number of captured frames has reached the specified maximum number of frames (YES), the processing proceeds to step S39. In a case where the number of captured frames has not reached the specified maximum number of frames (NO), the processing proceeds to step S35.

### (Step S35)

In a case where it is determined in step S34 that the number of captured frames has not reached the specified maximum number of frames (NO), the controller 101 allows imaging of the sub-imaging order. In a case where the processing proceeds to step S35 after returning from step S38 to step S34, the controller 101 allows imaging of an additional sub-imaging order.

(Steps S36 to S38) Steps S36 to S38 are the same as step S15 to S17 described in the flowchart illustrated in FIG. 6, and therefore, description thereof is omitted here. However, it is configured such that in a case where the next imaging is performed in step S38 (YES), the processing returns to step S34, and it is checked whether the number of captured frames have reached the specified maximum number of frames.

### (Step S39)

In a case where it is determined in step S34 that the number of captured frames has reached the specified maximum number of frames (YES), the controller 101 rejects imaging of the sub-imaging order.

### (Step S40)

The controller 101 causes, for example, the display 103 to perform an error display, does not add the sub-imaging order, and ends the series of processing.

As described above, in the present modification, it is possible to perform the radiation exposure management of the patient by determining whether a sub-imaging order is allowed to be added, and by prohibiting the addition of a sub-imaging order.

Note that, in a case where it is determined that the number of captured frames has reached the specified maximum number of frames, the controller 101 rejects imaging of the sub-imaging order with the main imaging order, and does not add the sub-imaging order. However, a new main imaging order may be generated depending on conditions. In this case, the imaging of the sub-imaging order may be allowed with the new main imaging order.

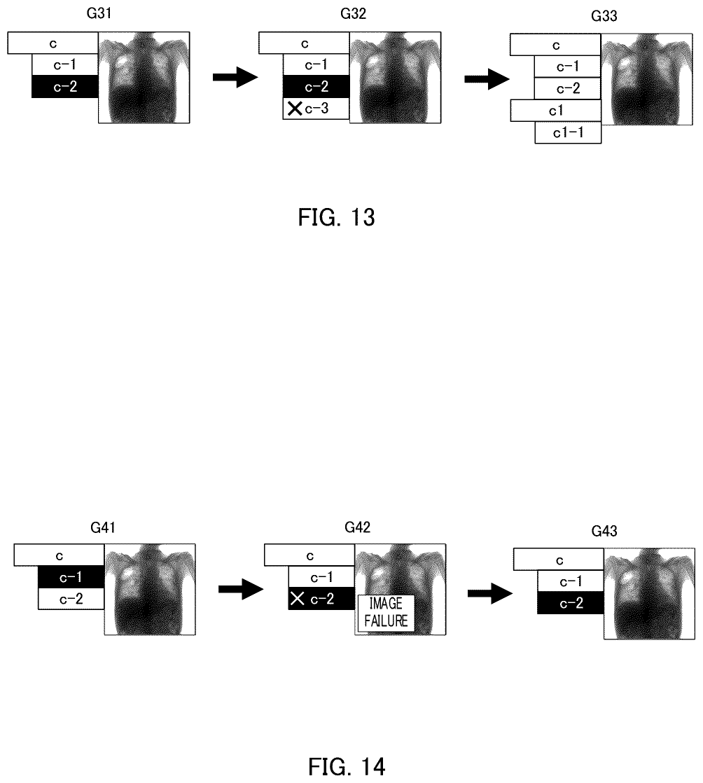

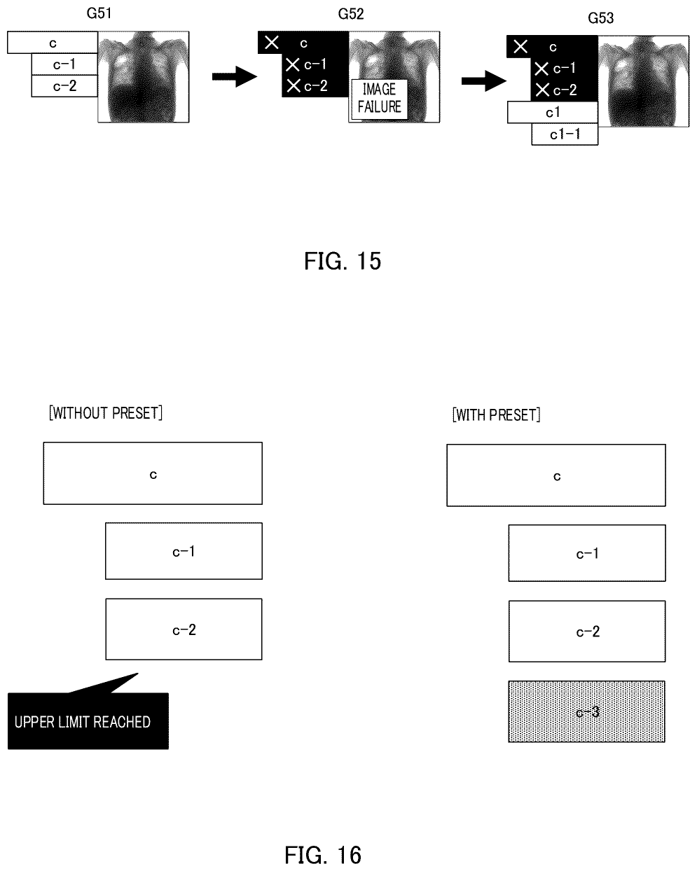

Here, examples of whether imaging is allowed to be added will be described with reference to FIGS. 13 to 15. FIG. 13 is a diagram schematically describing an example in which imaging of a sub-imaging order is not allowed to be added. FIG. 14 is a diagram schematically describing an example in which imaging is allowed to be added in a case where a captured image of a sub-imaging order is an image failure. FIG. 15 is a diagram schematically describing an example in which imaging is allowed to be added in a case where a captured image of a main imaging order is an image failure.

In the example illustrated in FIG. 13, with the main imaging order of the main imaging order ID: c, the sub-imaging orders of the sub-imaging orders ID: c-1 and c-2 are executed. Next, it is assumed that the number of captured frames has reached the specified maximum number of frames with the sub-imaging order of the sub-imaging order ID: c-2 (see a screen G31). In this case, an error display may be performed on the screen G31. However, in a case where the user attempts to perform the next imaging, a mark (for example, a black×mark) or the like indicating that addition is not allowed may be displayed on the sub-imaging order ID: c-3 of the next sub-imaging order to perform an error display as illustrated in a screen G32. In this case, the controller 101 causes the sub-imaging order ID: c-3 to be temporarily displayed in the list area, but rejects addition of the sub-imaging order to the sub-imaging order ID: c-3, that is, rejects additional imaging, and also does not create the sub-imaging order ID: c-3 associated with the main imaging order ID: c.

Note that, in the example illustrated in FIG. 13, the controller 101 rejects addition of a sub-imaging order with the main imaging order of the main imaging order ID: c, but may generate, depending on the conditions, a main imaging order of a new main imaging order ID: c1 as illustrated in a screen G33. In this case, the addition and imaging of the sub-imaging order of the sub-imaging order ID: c1-1 may be allowed with the main imaging order of the new main imaging order ID: c1.

Further, in the example illustrated in FIG. 13, for example, even in a case where the number of captured frames has reached the specified maximum number of frames with the sub-imaging order of the sub-imaging order ID: c-1, an error display may be performed at that time, or an error display may be performed on the next sub-imaging order c-2. Even in this case, the controller 101 causes the sub-imaging order ID: c-2 to be temporarily displayed in the list area, but does not create the sub-imaging order ID: c-2 associated with the main imaging order ID: c.

In the example illustrated in FIG. 14, the sub-imaging orders ID: c-1 and c-2 are executed with the main imaging order of the main imaging order ID: c. Then, it is assumed that an image failure has occurred with the sub-imaging order of the sub-imaging order ID: c-2 due to, for example, a loss of a target region, body motion, or the like (see screens G41 and G42). In this case, as illustrated in the screen G42, a mark (for example, a white×mark) or the like indicating the image failure is displayed on the sub-imaging order ID: c-2 with the image failure. Then, in a case where the number of captured frames including the sub-imaging order of the sub-imaging order ID: c-2 with the image failure has not reached the specified maximum number of frames, the controller 101 allows addition of a sub-imaging order of a new sub-imaging order ID: c-2. That is, the controller 101 allows additional imaging, and creates the new sub-imaging order ID: c-2 associated with the main imaging order ID: c.

In the example illustrated in FIG. 15, the sub-imaging orders of the sub-imaging orders ID: c-1 and c-2 are executed with the main imaging order of the main imaging order ID: c. Then, it is assumed that an image failure has occurred in all sub-imaging orders (the sub-imaging orders ID: c-1 and c-2) associated with the main imaging order of the main imaging order ID: c (see screens G51 and G52). In this case, as illustrated in the screen G52, a mark (for example, a white×mark) or the like indicating the image failure is displayed on the main imaging order ID: c and the sub-imaging orders ID: c-1 and c-2. Then, in a case where the number of captured frames including the sub-imaging orders ID: c-1 and c-2 with the image failure has not reached the specified maximum number of frames, the controller 101 allows a main imaging order of a new main imaging order ID: c1. In this case, the controller 101 also allows a new sub-imaging order ID: c1-1 associated with the main imaging order ID: c1, and creates the new sub-imaging order ID: c1-1 associated with the main imaging order ID: c1.

As described above, in the present modification, it is determined, based on whether the number of captured frames has reached the specified maximum number of frames, whether additional imaging is allowed, that is, whether a sub-imaging order is allowed to be added.

Note that, instead of the specified maximum number of frames, it may be determined whether additional imaging is allowed (whether a sub-imaging order is allowed to be added), by the following determinations.

### (Determination Pattern 1)

In a case where the number of frames captured from the operation start in one operation period according to one main imaging order has reached a predetermined number of frame smaller than the specified maximum number of frames, additional imaging (addition of a sub-imaging order) is rejected. For example, in a case where the specified maximum number of frames is 1000, the predetermined number of frames is 990, which is smaller than 1000. Thus, in a case where the number of remaining frames is smaller than the number of frames required for dynamic imaging, it is possible to prevent additional imaging from being interrupted and a patient from being unnecessarily exposed to radiation.

### (Determination Pattern 2)

In a case where the cumulative dose of radiation irradiated after the operation start of one operation period according to one main imaging order has reached a predetermined amount, additional imaging (addition of a sub-imaging order) is rejected. This makes it possible to manage the radiation exposure of the patient. The cumulative dose of radiation may be calculated based on at least one of the dose area product (DAP), the calculated DAP, and the incident dose calculation. Here, the calculated DAP is obtained by calculating a dose area product value instead of the area dosimeter. Preferably, the incident dose calculation is an incident dose on the patient surface. Further, instead of the cumulative dose of radiation, the cumulative number of irradiation frames, which is the cumulative number of frames obtained by radiation irradiation after the operation start of one operation period, may be used.

### (Determination Pattern 3)

In a case where the elapsed time from the operation start of one operation period according to one main imaging order has reached a predetermined time, additional imaging (addition of a sub-imaging order) is rejected. For example, the predetermined time is set to ten minutes, and imaging and interruption can be performed any number of times during the time. This is suitable for a case where an offset image is acquired in advance and a captured image is offset-corrected. Even when an offset variation occurs in a captured image, the image can be captured within the predetermined time without any problem in image quality.

### (Determination Pattern 4)

In a case where an imaging interruption period has reached a predetermined interruption time according to one operation period according to one main imaging order, additional imaging (addition of a sub-imaging order) is rejected. When the imaging interruption period becomes long, it is better to reset the FDP 3 from the viewpoint of imaging qualities, so that the imaging qualities can be maintained by once ending the operation in one operation period and resetting the FDP 3.

### (Determination Pattern 5)

In a case where the number of times of imaging according to the sub-imaging order has reached a predetermined number of times within one operation period according to one main imaging order, additional imaging (addition of the sub-imaging order) is rejected. There is also a case where it is difficult for the user to correctly grasp the imaging time and the irradiation dose of radiation, and managing the number of times of imaging, which can be performed, makes it easier to grasp the timing of the end of the operation within one operation period.

### (Determination Pattern 6)

In a case where the number of frames in dynamic imaging according to one sub-imaging order has exceeded a specified number in one operation period according to one main imaging order, additional imaging (addition of the sub-imaging order) is rejected. The specified number may be the above-described specified maximum number of frames or a predetermined number of frames smaller than the specified maximum number of frames.

### (Determination Pattern 7)

In a case where the user performs a termination operation in one operation period according to one main imaging order, additional imaging (addition of a sub-imaging order) is rejected. For example, in a case where a termination operation of pressing the FDP 3 switch is performed by the user or a termination operation is performed on a screen displayed on the display 103, additional imaging (addition of a sub-imaging order) is rejected.

At least one of the above-described determination patterns may be used to determine whether additional imaging is allowed, that is, whether a sub-imaging order is allowed to be added, which enables radiation exposure management, quality control, and/or the like.

The displaying indicating that additional imaging (addition of a sub-imaging order) is not allowed is not limited to the example illustrated in the screen G32 of FIG. 13, and may be an example illustrated in FIG. 16. FIG. 16 is a diagram illustrating exemplary displaying in a case where imaging of a sub-imaging order is not allowed to be added.

For example, in a case where there is no preset for sub-imaging orders, addition of imaging of a sub-imaging order is not allowed is displayed using, for example, a color and/or a message, below the sub-imaging order ID: c-2 that is the last sub-imaging order (here, as an example, “upper limit reached” is displayed). A warning sound or a warning voice may be output together with this displaying.

Further, in a case where there is a preset for sub-imaging orders, it is displayed, by performing grayed-out displaying at the sub-imaging order ID: c-3, which is a sub-imaging order that is not allowed to be added, or the like, that a sub-imaging order of the sub-imaging order ID: c-3 is not allowed to be performed. A warning sound or a warning voice may be output together with this displaying.

In this way, since the user is allowed to distinguish whether a sub-imaging order is allowed to be added, the user can perform the next apparatus operation without reducing operability.

Any of the embodiment described above is only illustration of an exemplary embodiment for implementing the present invention, and the technical scope of the present invention shall not be construed limitedly thereby. That is, the present invention can be implemented in various forms without departing from the gist or the main features thereof.

Although embodiments of the present invention have been described and illustrated in detail, the disclosed embodiments are made for purpose of illustration and example only and not limitation. The scope of the present invention should be interpreted by terms of the appended claims.

What is claimed is:

1. A radiographic imaging apparatus, comprising:
an imager that performs irradiation of radiation and performs still image capturing and dynamic image capturing;
at least one hardware processor that controls the imager such that the imager operates in a first imaging mode in which the imager performs one or both of the still image capturing and the dynamic image capturing a plurality of times between a start of an operation of the imager and an end of the operation of the imager according to one imaging instruction; and
a storage that stores information in association with images for the plurality of times, the information being information on the one imaging instruction, the images for the plurality of times having been captured in the first imaging mode.

2. The radiographic imaging apparatus according to claim 1, wherein
the at least one hardware processor changes a number of times of imaging in the first imaging mode based on the one imaging instruction.

3. The radiographic imaging apparatus according to claim 1, wherein
the at least one hardware processor
determines whether an increase in a number of times of imaging in the first imaging mode is allowed, and
increases the number of times of imaging in a case where the increase is allowed.

4. The radiographic imaging apparatus according to claim 3, wherein
the at least one hardware processor determines whether the increase in the number of times of imaging is allowed based on one of the number of frames of images captured from the start of the operation, a cumulative dose of the radiation from the start of the operation, and a cumulative number of irradiation frames from the start of the operation.

5. The radiographic imaging apparatus according to claim 1, wherein:
the at least one hardware processor sets, in association with the one imaging instruction, a plurality of sub-imaging instructions each of which corresponds to a number of times of imaging in the first imaging mode, and
the storage stores each information on the plurality of sub-imaging instructions in association with images captured according to a corresponding sub-imaging instruction among the plurality of sub-imaging instructions.

6. The radiographic imaging apparatus according to claim 5, further comprising
a display that visually displays association between the information on the one imaging instruction and information on the plurality of sub-imaging instructions.

7. The radiographic imaging apparatus according to claim 5, wherein
in a case where the one imaging instruction is deleted, the at least one hardware processor deletes the sub-imaging instructions associated with the one imaging instruction.

8. The radiographic imaging apparatus according to claim 1, wherein:
the at least one hardware processor controls the imager such that the imager operates in a second imaging mode different from the first imaging mode, and
the second imaging mode is a mode in which the still image capturing or the dynamic image capturing is performed once.

9. The radiographic imaging apparatus according to claim 5, further comprising
an outputter that outputs the images for the plurality of times for the information on the one imaging instruction each time or for each information on the plurality of sub-imaging instructions, the images for the plurality of times being associated with the information on the one imaging instruction.

10. A radiographic imaging method, comprising:
controlling, by a radiographic imaging apparatus including an imager that performs irradiation of radiation and performs still image capturing and dynamic image capturing, the imager such that the imager operates in a first imaging mode in which the imager performs one or both of the still image capturing and the dynamic image capturing a plurality of times between a start of an operation of the imager and an end of the operation of the imager according to one imaging instruction; and
storing, by the radiographic imaging apparatus, information in association with images for the plurality of times, the information being information on the one imaging instruction, the images for the plurality of times having been captured in the first imaging mode.

11. A non-transitory computer-readable recording medium storing a radiographic imaging program that causes a computer of a radiographic imaging apparatus to execute, the radiographic imaging apparatus including an imager that performs irradiation of radiation and performs still image capturing and dynamic image capturing:
controlling the imager such that the imager operates in a first imaging mode in which the imager performs one or both of the still image capturing and the dynamic image capturing a plurality of times between a start of an operation of the imager and an end of the operation of the imager according to one imaging instruction; and
storing information in association with images for the plurality of times, the information being information on the one imaging instruction, the images for the plurality of times having been captured in the first imaging mode.
